(19) United States
(12) Patent Application Publication
(10) Pub. No.: US 2025/0208715 A1
(43) Pub. Date: Jun. 26, 2025

(54) IMAGE PROCESSING APPARATUS AND IMAGE PROCESSING METHOD

(71) Applicant: CANON KABUSHIKI KAISHA, Tokyo (JP)

(72) Inventors: KOJI TOGITA, Kanagawa (JP); YUSHI KANEKO, Kanagawa (JP)

(21) Appl. No.: 18/985,978

(22) Filed: Dec. 18, 2024

(30) Foreign Application Priority Data
Dec. 21, 2023 (JP) 2023-216197

(51) Int. Cl. G06F 3/01; G06T 5/73

(52) U.S. Cl. CPC G06F 3/016; G06T 5/73

(57) ABSTRACT

An image processing apparatus applies image processing to image data with which haptics data to be used to elicit senses of touch and force is associated. If image processing, which relates to a change of a value set for the image data, has been applied to the image data, the image processing apparatus changes first haptics data, which is haptics data associated with, in the image data, data of an area to which the image processing has been applied, to elicit senses of touch and force corresponding to an image represented by the data of the area after the image processing has been applied.

### BACKGROUND

### Technical Field

This disclosure relates to an image processing apparatus and an image processing method, and particularly to an image processing apparatus and an image processing method that enables handling image data accompanied by information for reproducing a tactile sensation or sense of force.

### Description of the Related Art

In recent years, haptics technology that elicits in a user with a tactile sensation or force sensation has been attracting attention (WO 2021/009864). Haptics technology can provide a user with information that cannot be obtained through a sense of sight or a sense of hearing, such as information about a tactile quality and a hardness of an object.

It is conceivable, for example, to record moving image data in association with information (haptics data) for eliciting a haptic sensation related to a subject in a user. By eliciting a tactile impression in a user via a known haptic interface apparatus that uses an actuator or the like during playback of moving image data, a richer user experience can be achieved.

### SUMMARY

Accordingly, one aspect of the present disclosure provides an image processing apparatus and an image processing method that enables appropriately handling image data with which information for eliciting a tactile impression of a subject is associated.

More specifically, according to an aspect of the present disclosure, an image processing apparatus that applies image processing to image data with which haptics data to be used to elicit senses of touch and force is associated, comprises one or more processors that execute a program stored in a memory to change, if image processing, which relates to a change of a value set for the image data, has been applied to the image data, first haptics data, which is haptics data associated with, in the image data, data of an area to which the image processing has been applied, to elicit senses of touch and force corresponding to an image represented by the data of the area after the image processing has been applied.

According to another aspect of the disclosure, an image processing method for applying image processing to image data with which haptics data to be used to present a sense of touch and force is associated, comprises changing, if image processing relating to a change of a value set for the image data has been applied, first haptics data, which is haptics data associated with, in the image data, image data of an area to which the image processing has been applied, to elicit senses of touch and force corresponding to an image represented by the image data of the area after the image processing has been applied.

According to yet another aspect of the disclosure, a non-transitory computer-readable medium storing a program having instructions that, when executed by a computer, cause the computer to execute an image processing method for applying image processing to image data with which haptics data to be used to present a sense of touch and force is associated, comprises changing, if image processing relating to a change of a value set for the image data has been applied, first haptics data, which is haptics data associated with, in the image data, image data of an area to which the image processing has been applied, to elicit senses of touch and force corresponding to an image represented by the image data of the area after the image processing has been applied.

Further features of the present disclosure will become apparent from the following description of exemplary embodiments with reference to the attached drawings.

### BRIEF DESCRIPTION OF THE DRAWINGS

FIG. 1 is a block diagram illustrating an example of a functional configuration of an image processing apparatus according to an embodiment.

FIG. 2 is a schematic diagram illustrating an example of a configuration of image data with which haptics data is associated.

FIGS. 3A to 3C are schematic diagrams illustrating an example of an association between image data and haptics data.

FIG. 4 is a flowchart relating to an operation of a haptics data processing unit according to an embodiment.

FIGS. 5A and 5B are diagrams for illustrating an example of a change of haptics data accompanying a change of color temperature.

FIGS. 6A to 6C are diagrams for illustrating an example of a change of haptics data accompanying a change of color temperature.

FIG. 7 is a flowchart illustrating details of processing of step S403 in FIG. 4.

FIG. 8 is a schematic diagram illustrating an example of a change of haptics data accompanying image processing for reducing sharpness.

FIGS. 9A to 9D are schematic diagrams illustrating an example of a change of haptics data accompanying image processing for reducing sharpness.

FIGS. 10A to 10C are schematic diagrams illustrating an example of a change of haptics data accompanying image processing for reducing sharpness.

FIG. 11 is a flowchart relating to a second embodiment.

FIGS. 12A to 12D are diagrams for illustrating operations of an image data processing unit and a haptics data processing unit according to a third embodiment.

FIGS. 13A and 13B are diagrams for illustrating operations of the image data processing unit and the haptics data processing unit according to the third embodiment.

FIGS. 14A and 14B are diagrams for illustrating operations of the image data processing unit and the haptics data processing unit according to the third embodiment.

FIGS. 15A and 15B are diagrams for illustrating operations of the image data processing unit and the haptics data processing unit according to the third embodiment.

FIGS. 16A and 16B are diagrams for illustrating operations of the image data processing unit and the haptics data processing unit according to the third embodiment.

FIGS. 17A and 17B are diagrams for illustrating operations of the image data processing unit and the haptics data processing unit according to the third embodiment.

FIGS. 18A and 18B are diagrams for illustrating operations of an image data processing unit and a haptics data processing unit according to a fourth embodiment.

FIGS. 19A and 19B are diagrams for illustrating operations of the image data processing unit and the haptics data processing unit according to the fourth embodiment.

FIG. 20 is a flowchart illustrating operations of the haptics data processing units according to the third and fourth embodiments.

### DESCRIPTION OF THE EMBODIMENTS

Hereinafter, embodiments will be described in detail with reference to the attached drawings. The following embodiments are not intended to limit the scope of the claims. While multiple features are described in the embodiments, not all features are essential, and some features can be combined as appropriate. In the attached drawings, the same reference numerals are provided to the same or similar configurations, and redundant description thereof is omitted.

### First Embodiment

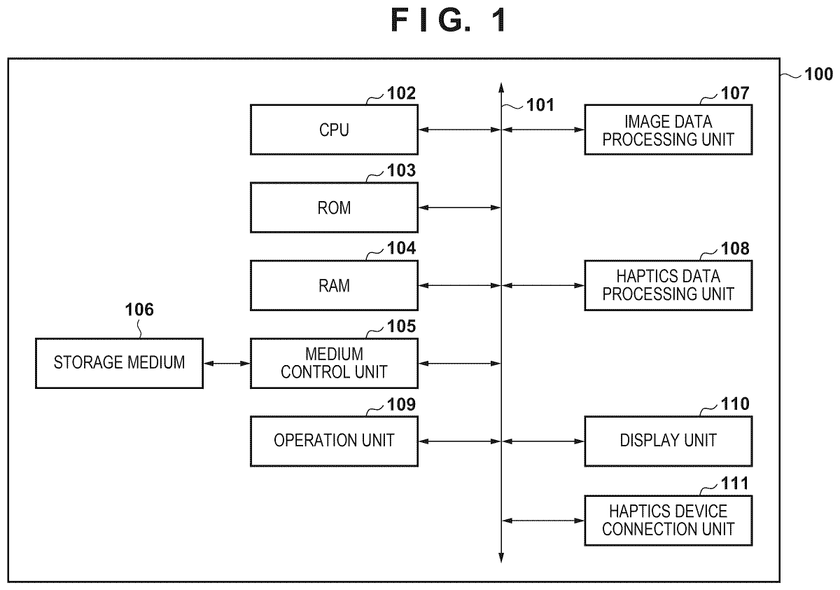

FIG. 1 is a block diagram illustrating an example of a functional configuration of an image processing apparatus 100 according to an embodiment of the present disclosure. The image processing apparatus 100 can be a computer device such as a desktop or notebook personal computer, or a tablet computer. The image processing apparatus 100 can also be implemented in an electronic device having one or more processors that execute an application program, such as a digital camera, a media player, a mobile information terminal (PDA), a smartphone, or a game console.

The image processing apparatus 100 handles information (haptics data) that represents a haptic sensation (a touch sensation, a force sensation, a temperature sensation, etc.), but does not need to have a sensor that acquires the haptics data or a haptic sensation interface apparatus that reproduces the haptics data and elicits the haptic sensation in the user.

Before describing the functional configuration of the image processing apparatus 100, the image data handled by the image processing apparatus 100 will be described. The image data is data representing a still image or a moving image, and has haptics data associated therewith. There is no limitation on the method of association, but it is assumed that the image data and the haptics data are stored in one data file using, for example, a known storage format.

The haptics data can be stored in a data file separate from the data file in which the image data is stored. In this case, the association of the data files can be achieved with any known method, such as providing commonality to the file names of the two data files or including information specifying the associated data files as metadata or the like.

Haptics data is data for eliciting specific touch and force sensations by controlling devices such as a motor, an actuator, a vibrator, or a heater of a haptic sensation interface apparatus that elicits haptic sensations. The haptics data can be generated by a known technology based on values detected by various sensors. The present disclosure does not depend on the method for generating haptics data or the configuration of the data. Accordingly, the content of the haptics data will be described only to the minimum extent necessary to implement the content of the disclosure.

FIG. 2 is a diagram schematically illustrating an example of a configuration of image data associated with haptics data, which is handled in this embodiment. It is assumed that the image data is data for one frame of a video or a still image. It is also assumed that the haptics data and image data are stored in the same data file.

An image data file 200 includes image data 201 and haptics data 202 associated with the image data 201. The haptics data 202 is associated with each area obtained by dividing the image represented by the image data 201. In FIG. 2, the haptics data 202 is depicted as being arranged two-dimensionally to facilitate understanding of the correspondence with the image, but the actual data structure can be different.

Haptics data 203 associated with an image area (hereinafter referred to as area haptics data 203) includes one or more combinations of perception type information 204 and strength information 205 (hereinafter referred to as unit haptics data). The shape and size of the area with which the area haptics data 203 is associated do not need to be constant. For example, the area haptics data 203 can be associated with each pixel, or one piece of area haptics data 203 can be associated with the entire image. There can be areas of different sizes. The area haptics data 203 can be associated with a specific subject area included in the image. There can be an area in an image with which no area haptics data 203 is associated.

The perception type information 204 is information that indicates the type of perception. The type of perception is not limited to the type of the perception itself, such as temperature, rigidity, or friction, and can also be the type of a specific object evoked by the perception, such as the sensation of wind, water, or spines. The strength information 205 indicates the intensity of the perception in levels such as strong, intermediate, and weak. For types of perception that cannot be expressed in intensity or strength levels, such as temperature, other expressions can be used, such as using the temperature itself or a different numerical value corresponding to the temperature. There is no particular limitation on the configuration of the haptics data, and the haptics data can have a structure or an element different from those of the examples described above. The haptics data can conform to a future standard or can use a proprietary format.

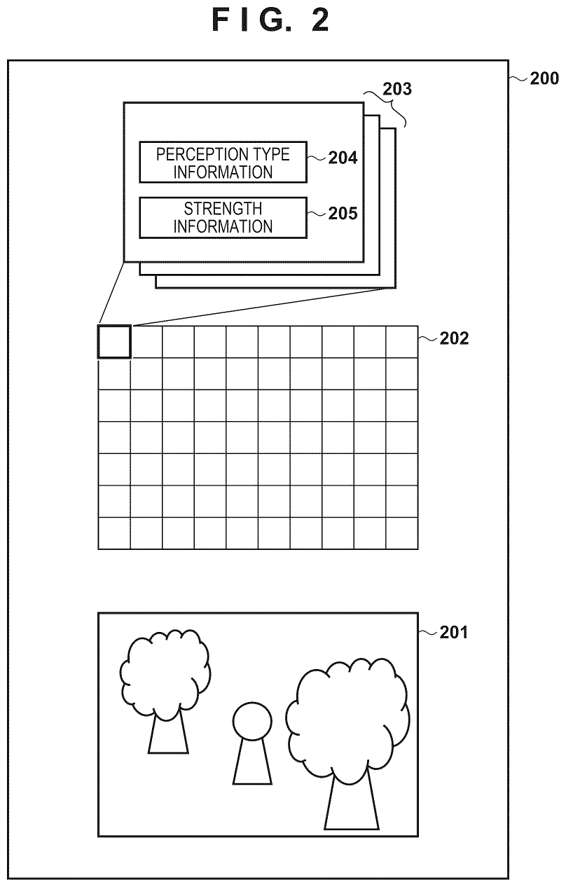

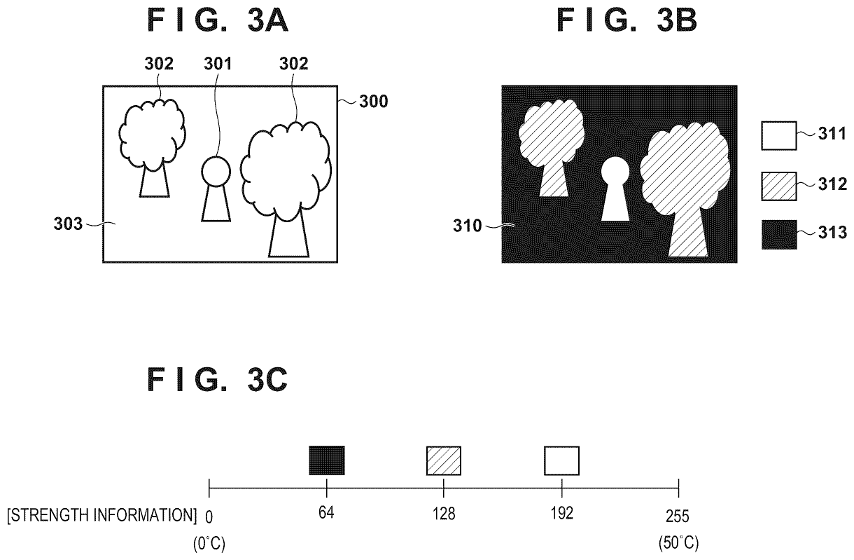

FIGS. 3A to 3C are diagrams illustrating a relationship between image data and haptics data. It is assumed that area haptics data 203 having unit haptics data in which the perception type information 204 is temperature is associated with an image.

FIG. 3A illustrates an image 300 represented by the image data. The image 300 includes one human subject 301, two tree subjects 302, and a background 303. FIG. 3B illustrates, in terms of sense of sight, area haptics data for each rectangular area obtained by dividing the image 300 illustrated in FIG. 3A in both horizontal and vertical directions.

Area haptics data 311 is associated with the area of the human subject 301, area haptics data 312 is associated with the areas of the two tree subjects 302, and area haptics data 313 is associated with the background 303. Each piece of area haptics data 311 to 313 includes unit haptics data in which the perception type information 204 is temperature and the strength information 205 indicates a different temperature.

The area haptics data 311 or 312 is associated with rectangular areas that include a portion of the subject areas, and the area haptics data 313 is associated with the other areas. As described above, the area haptics data can be associated with a subject area as a unit.

It is assumed that if the perception type information 204 is “temperature”, the strength information 205 is described as a numerical value corresponding to a specific temperature. FIG. 3C illustrates an example of a relationship between numerical values and temperatures. In FIG. 3C, the strength information is an 8-bit value (0 to 255) representing a range of 0 to 50° C. Also, it is assumed that the haptics data 311 to 313 have strength information of 192, 128, and 64, respectively. The correspondence between the range of the strength information and the associated temperature range can be included in the area haptics data 203, for example, as unit haptics data having specific perception type information 204, or as information other than perception type information 204 and strength information 205.

A haptic sensation interface apparatus that elicits a sense of temperature or a control apparatus thereof can use strength information included in unit haptics data in which the perception type information is temperature to elicit a sense of temperature. For example, when a touch operation is detected while the image 300 is being displayed on a touch display, a haptic sensation interface apparatus can be controlled based on haptics data associated with an area including the coordinates where the touch operation was detected, to elicit a sense of temperature in a user of the apparatus.

Returning to FIG. 1, the configuration of the image processing apparatus 100 will be described. A CPU 102 is one or more processors that execute programs. The CPU 102 loads a program stored in, for example, a ROM 103 or a storage medium 106 into a RAM 104 and executes the loaded program. The CPU 102 executes the program and controls the operation of each functional block to realize the functions of the image processing apparatus 100, including an image editing operation, which will be described below.

The ROM 103 is, for example, an electrically rewritable non-volatile memory, and stores programs executable by the CPU 102, setting values, GUI data, and the like.

The RAM 104 is used to load the programs to be executed by the CPU 102 and store values required during the execution of the programs. In addition, a part of the RAM 104 can be used as a video memory for a display unit 110.

The storage medium 106 has a larger storage capacity than the ROM 103 and stores basic software (OS), application programs, user data, and the like. Image data handled by the image processing apparatus 100 and application programs for handling the image data are stored in the storage medium 106. The storage medium 106 can be, for example, a hard disk drive (HDD), a solid state drive (SSD), a removable memory card, or the like.

The medium control unit 105 controls writing of data to the storage medium 106 and reading of data from the storage medium 106 based on instructions from the CPU 102. The medium control unit 105 reads data from the storage medium 106 in fixed size increments based on a read command from the CPU 102 and stores the data in the RAM 104. In addition, the medium control unit 105 writes data to be written, which is stored in the RAM 104, into the storage medium 106 in fixed size increments in accordance with a write command from the CPU 102. When the medium control unit 105 completes reading or writing of data based on the command, the medium control unit 105 notifies the CPU 102 of the completion. The functions of the medium control unit 105 can also be executed by the CPU 102.

An operation unit 109 is an input device that can be operated by a user, and can be a keyboard, a mouse, a touch pad, or the like. In addition, the operation unit 109 can include an external input device. If the display unit 110 is a touch display, the touch panel of the display unit 110 is included in the operation unit 109. When the CPU 102 detects an operation on the operation unit 109, the CPU 102 executes an operation corresponding to the detected operation.

The display unit 110 displays a GUI (menus, windows, etc.) provided by the OS and application programs. The image data stored in the moving image memory area of the RAM 104 is displayed on the display unit 110. If the display unit 110 is a touch display, software keys can be realized by combining images displayed on the display unit 110 with the touch panel. The display unit 110 does not need to be an integrated element of the image processing apparatus 100, and can also be an external device.

An image data processing unit 107 provides the user with functions related to editing and modifying image data associated with haptics data. The image data processing unit 107 enables editing and modification of image data to be edited that is selected by the user from among the image data stored in the storage medium 106. The functions provided by the image data processing unit 107 can be the same as the functions provided by known retouching applications and video editing applications. Some examples of functions include, but are not limited to, tone correction, color correction, brightness correction, white balance adjustment, area cutting (trimming), compositing, scaling, combining/splitting/deleting files (clips), and adding various effects.

The image data processing unit 107 notifies a haptics data processing unit 108 of image modification information every time editing or modification (hereinafter referred to as image processing) is applied to the image data. The image modification information includes information indicating the content of the applied image processing (type of processing and, for example, processing amount) and information indicating the area to which the editing or modification has been applied. The information indicating the content of the image processing can differ depending on the type of processing. The image data processing unit 107 also notifies the haptics data processing unit 108 of image modification information when application is cancelled (undone).

Moving image data is edited interactively by a user operating a GUI provided on the display unit 110 by an editing application executed by the CPU 102, via the operation unit 109. The CPU 102 edits the moving image data based on the GUI operated via the operation unit 109 and the operation content, and displays the editing result. Since such editing of image data is known, further details will not be described herein.

The haptics data processing unit 108 modifies the haptics data associated with the image data based on the image processing that the image data processing unit 107 applies to the image data. Specifically, based on the image modification information notified from the image data processing unit 107, the haptics data processing unit 108 modifies the haptics data associated with the image to be consistent with the image represented by the image data to which image processing has been applied. The operation of the haptics data processing unit 108 will be described in detail below.

Both the image data processing unit 107 and the haptics data processing unit 108 can be implemented using hardware circuits such as ASIC, FPGA, and GPU. Alternatively, the processing described below as the operations of the image data processing unit 107 and the haptics data processing unit 108 can be realized by the CPU 102 executing an image processing application program.

The moving image data (including haptics data) being edited is temporarily stored in the RAM 104. When a save instruction from the user or an instruction to complete editing is detected, the CPU 102 stores the data stored in the RAM 104 in the storage medium 106 via the medium control unit 105.

A haptics device connection unit 111 is an interface for connecting a haptic sensation interface apparatus that elicits the senses of touch and force in the user based on haptics data. The haptics device connection unit 111 can be a communication interface that is generally used to connect a computer device and an external device to each other to be able to communicate, or can be a dedicated interface. The haptics device connection unit 111 can include, for example, one or more of a USB interface, a Bluetooth® interface, an NFC interface, and the like.

The haptic sensation interface apparatus can be, for example, a glove-like device having a device that generates vibration or pressure (a motor, actuator, vibrator, etc.) and a device with a variable temperature (a heater, Peltier element, etc.). When a user wears the haptic sensation interface apparatus on the user's hand and touches the display unit 110, which is a touch display, output for eliciting senses of touch and force corresponding to an image of the touched position is performed. For example, a user can experience the texture and temperature of a subject appearing in the image at the touched position.

In some cases, the image processing apparatus 100 has integrated elements such as a vibrator or an actuator that can be used as a haptic sensation interface apparatus that elicits senses of touch and force in a user through a housing and/or the display unit 110 of the image processing apparatus 100. In this case, the integrated elements that can be used as a haptic sensation interface apparatus can be considered to be connected to the haptics device connection unit 111.

The functional blocks other than the storage medium 106 are connected to each other via a bus 101 to be able to communicate with each other. The bus 101 includes an address bus, a data bus, and a control bus.

### Haptics Data Processing

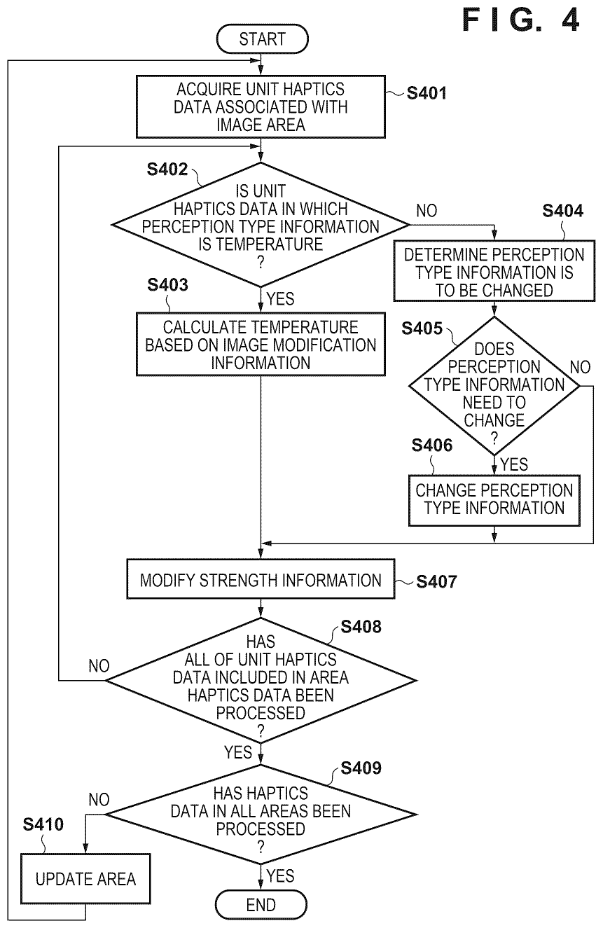

FIG. 4 is a flowchart relating to the operation of the haptics data processing unit 108. For example, it is assumed that an image editing application program is being executed by the CPU 102 in the image processing apparatus 100. When the CPU 102 detects that an instruction to edit or modify image data to be edited has been input via the operation unit 109, the CPU 102 instructs the image data processing unit 107 to apply processing based on the input instruction to the image data.

The image data processing unit 107 applies processing corresponding to the instruction to the image data, and stores the image data to which the processing has been applied in the video memory area in the RAM 104. As a result, the processing is reflected in the image data being edited that is being displayed on the display unit 110. In addition, the image data processing unit 107 notifies the haptics data processing unit 108 of image modification information.

The haptics data is assumed to be include the area haptics data 203 associated with each area of the image as shown in FIG. 2. Each time image modification information is notified from the image data processing unit 107, the haptics data processing unit 108 specifies the area to which the image processing was applied based on the image modification information. Then, the haptics data processing unit 108 executes the operation illustrated in the flowchart of FIG. 4 on the area haptics data associated with the area to which the image processing was applied.

In step S401, the haptics data processing unit 108 acquires the area haptics data associated with the image area. The haptics data processing unit 108, for example, can acquire the target area haptics data from the haptics data stored in the RAM 104 together with the image data being edited. If the target area haptics data can be specified, the area haptics data does not need to be read out to the haptics data processing unit 108.

In step S402, the haptics data processing unit 108 determines whether the target area haptics data includes unit haptics data in which the perception type information is temperature. If it is determined that it is included, the haptics data processing unit 108 executes step S403. If it is determined that it is not included, the haptics data processing unit executes step S404.

In step S403, the haptics data processing unit 108 calculates temperature information based on the content of the processing applied to the image area. For example, the haptics data processing unit 108 determines whether the type of processing corresponds to a predetermined processing that affects temperature. The processing that affects temperature can, for example, be processing that changes the color temperature or processing that changes the brightness. These processings are not seen to be limiting.

If it is determined that the type of processing corresponds to processing that affects the temperature, the haptics data processing unit 108 calculates a temperature (strength information) corresponding to the processing amount. The haptics data processing unit 108 can calculate the temperature by, for example, applying a gain corresponding to the processing amount to the temperature described in the strength information of the current unit haptics data. The gain can be determined based on, for example, a table or a calculation formula that describes the relationship between the processing amount and the gain, which is predetermined for each type. The relationship between the processing amount and the gain is determined such that the change in the image resulting from processing matches the generally-associated temperature change, such as increasing the temperature in the case of processing for lowering the color temperature (increasing redness), and reducing the temperature in the case of processing for raising the color temperature (increasing blueness). Accordingly, in the case of brightness, the relationship between the processing amount and the gain is determined such that the temperature rises as the brightness increases and the temperature falls as the brightness decreases. In the image modification information, the direction of processing (increase/decrease, +/−, etc.) is indicated by the sign of the processing amount or other information. After calculating the temperature, the haptics data processing unit 108 executes processing for updating the strength information with the calculated temperature in step S407.

The strength information (temperature) of the haptics data with the perception type information “temperature” associated with the image to which image processing was applied can also be calculated by adding (or subtracting) an offset value to (or from) the strength information.

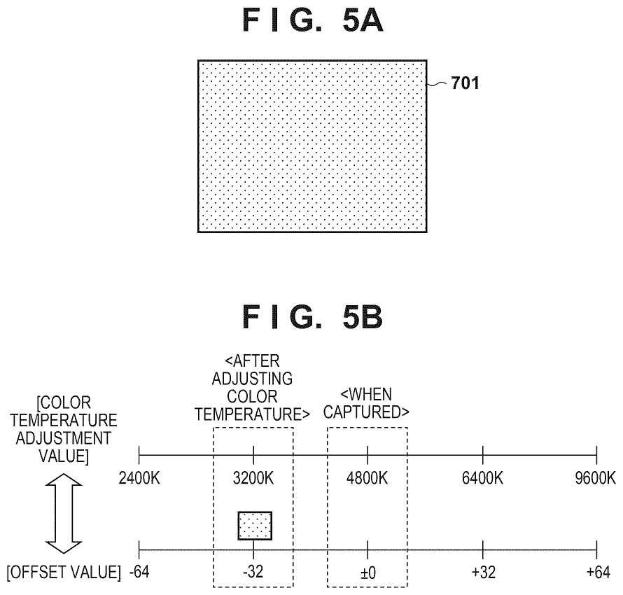

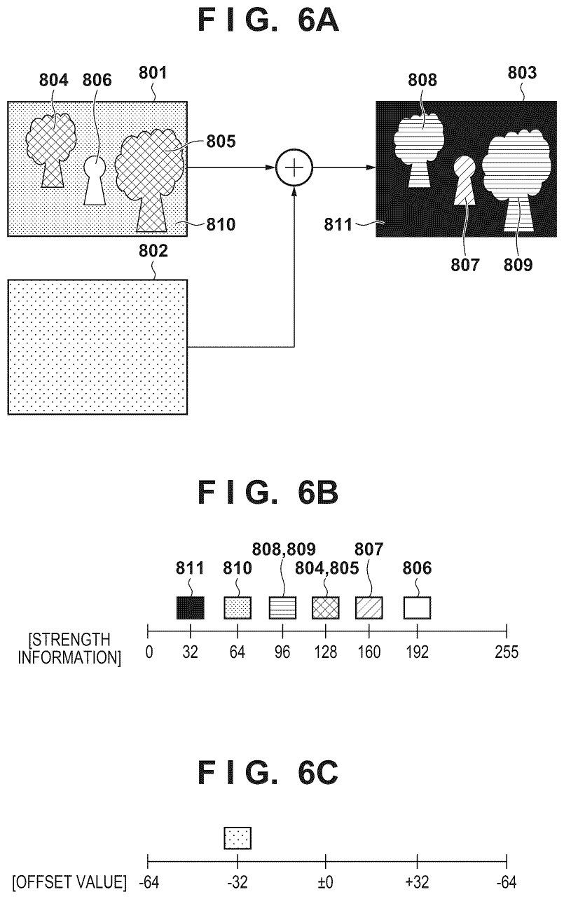

A method for calculating strength information of haptics data with perception type information “temperature” using an offset value when the image data processing unit 107 applies color temperature adjustment to image data will be described with reference to FIGS. 5 to 6C. The temperature is calculated by modifying the strength information of the temperature by adding or subtracting a predetermined value corresponding to the image processing. Hereinafter, the value added to or subtracted from the strength information will be referred to as an offset value.

As an example, it is assumed that the color temperature of ambient light in image data captured with a color temperature setting of 4800 K has been adjusted to 3200 K via image processing performed by the image data processing unit 107. If the color temperature adjustment is applied, the image data processing unit 107 includes the color temperatures before and after the adjustment in the image modification information as the processing amount.

FIG. 5B illustrates an example of the relationship between the processing amount (color temperatures before and after the change) in the image modification information and the offset value. If the color temperature is adjusted to a value lower than that at the time of shooting, the image will appear bluer than before the adjustment. Generally, blue is associated with coldness, and therefore the offset value applied to the temperature is a negative value. If the color temperature is adjusted to a value higher than that at the time of shooting, the image will appear redder than before the adjustment. Generally, redness evokes warmth, and therefore the offset value applied to the temperature is a positive value. The relationship between the amount of change in the color temperature and the magnitude of the offset value can differ depending on the value of the color temperature before the change. Accordingly, a table or the like indicating the relationship between the amount of change and the offset value based on the color temperature before the change can be prepared in advance.

It is assumed that an adjustment from 4800 K to 3200 K is applied, and therefore the offset value is −32. If the color temperature adjustment is applied to the entire image, a uniform offset value (−32) is distributed across the entire image, as indicated schematically by reference numeral 701 in FIG. 5A.

In FIG. 6A, reference numeral 801 schematically indicates a distribution of strength information of haptics data with the perception type information “temperature”, which is associated with the image 300 before image processing is applied to the image 300.

Reference numeral 802 schematically indicates the offset value and its distribution determined by the haptics data processing unit 108 based on the image modification information. The same applies to FIG. 5A.

Reference numeral 803 schematically indicates the values and distribution of the strength information after modification, in which an offset value indicated by reference numeral 802 is applied (added) to the strength information indicated by reference numeral 801.

Before image processing is applied, a human subject 806, two tree subjects 804 and 805, and a background 810 included in the image 300 are associated with haptics data with the perception type information “temperature” having strength information of 192, 128, and 64, respectively. As a result of applying image processing to change the color temperature from 4800 K to 3200 K, an offset value of −32 is uniformly applied to the strength information. As a result, the strength information of the human subject 807, the two tree subjects 808 and 809, and the background 811 in the image to which the image processing has been applied is changed to 160, 96, and 32, respectively.

In step S403, the calculation (determination) of the offset value is executed, and the processing for modifying the strength information using the offset value is executed in step S407.

The haptics data processing unit 108 modifies (changes) the haptics data based on image modification information from the image data processing unit 107 to suppress any sense of incongruity resulting from inconsistency between the image after image processing has been applied and the output for eliciting the senses of touch and force. For example, a case is considered in which image processing for changing the color temperature reduces the redness of an area associated with haptics data that presents warmth. Unless the haptics data is modified, the user will experience a sense of incongruity because warmth is still presented despite the reduction in redness. According to the present embodiment, the haptics data is changed to lower the temperature presented by the haptics data processing unit 108, and therefore the likelihood that the user will feel a sense of incongruity can be reduced.

A change of the haptics data is automatically made accompanying the application of image processing. For this reason, the user need only interactively apply image processing without being aware of whether haptics data is associated with the image data being processed.

If the processing is of a type that does not affect the temperature, the haptics data processing unit 108 does not calculate the temperature. In this case, the haptics data processing unit 108 can skip step S407 and execute step S408.

In step S404, the haptics data processing unit 108 determines whether the perception type information is to be changed. If it is determined that the perception type information is to be changed, the haptics data processing unit 108 determines the perception type information after the change. The operation of step S404 will be described below.

In step S405, the haptics data processing unit 108 branches the processing depending on the determination result in step S404. Specifically, if it is determined that the perception type information is to be changed, the haptics data processing unit 108 executes step S406. If it is determined that the perception type information is not to be changed, the haptics data processing unit 108 executes step S407.

In step S406, the haptics data processing unit 108 changes the perception information type of the unit haptics data to be processed to the type determined in step S404. Thereafter, the haptics data processing unit 108 executes step S407.

In step S407, the haptics data processing unit 108 modifies (changes) the strength information of the unit haptics data. Detailed description will be provided below.

In step S408, the haptics data processing unit 108 determines whether all of the unit haptics data included in the area haptics data has been processed. If it is determined that all of the unit haptics data has been processed, the haptics data processing unit 108 executes step S409. If the haptics data has not been processed, the haptics data processing unit 108 executes step S402 for the unprocessed unit haptics data.

In step S409, the haptics data processing unit 108 determines whether there is an image area for which the processing of the area haptics data has not been completed. If it is determined that there is such an image area, the processing advances to step S410. If it is determined that there is no such image area, the haptics data processing unit 108 ends the operation of the flowchart in FIG. 4.

In step S410, the haptics data processing unit 108 updates the image area to be processed, and executes the processing of step S401 and the rest of the processing.

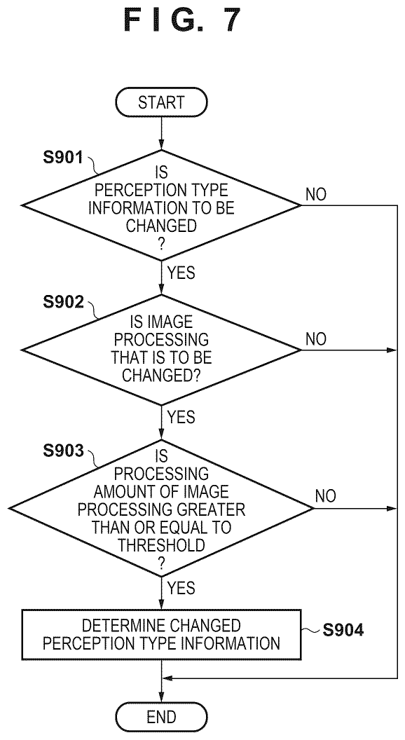

Next, the operation of the haptics data processing unit 108 in step S404 will be described with reference to the flowchart shown in FIG. 7.

In step S901, the haptics data processing unit 108 refers to the perception type information 204 of the unit haptics data to be processed, and determines whether the unit haptics data corresponds to a predetermined type to be changed. It is assumed that types other than temperature are to be changed. If it is determined that the unit haptics data to be processed is of a predetermined type to be changed, the haptics data processing unit 108 executes step S902. If it is determined that the unit haptics data to be processed is not of a predetermined type, the haptics data processing unit 108 ends the processing of FIG. 7 since there is no need to change the perception type information.

In step S902, the haptics data processing unit 108 determines whether the image processing applied to the area corresponds to predetermined processing to be subjected to a change. The haptics data processing unit 108 can make the determination by, for example, referring to a list of predetermined processing to be subjected to a change, using information indicating the content of image processing extracted from the image modification information. The list of processing to be subjected to a change can be different for each type of perception. Accordingly, the haptics data processing unit 108 can determine whether the image processing included in the list of processing to be subjected to a change that corresponds to the perception type information of the unit haptics data to be processed has been applied.

If it is determined that the image processing applied to the area corresponds to predetermined processing to be subjected to a change, the haptics data processing unit 108 executes step S903. If it is determined that the image processing applied to the area does not correspond to the predetermined processing, the haptics data processing unit 108 ends the processing of FIG. 7 since there is no need to change the perception type information.

In step S903, the haptics data processing unit 108 determines whether the processing amount of the image processing applied to the area is greater than or equal to a predetermined threshold. If it is determined that the amount of image processing is greater than or equal to the threshold, the haptics data processing unit 108 executes step S904. If it is determined that the amount of image processing is less than the threshold, the haptics data processing unit 108 ends the processing of FIG. 7 since there is no need to change the perception type information. The haptics data processing unit 108 can make the determination by, for example, comparing a threshold value that is predetermined for at least one of the types of image processing and one of the types of perception with the processing amount included in the image modification information. The processing amount does not necessarily need to be a numerical value. If the processing amount is not a numerical value, in step S903, the haptics data processing unit 108 determines whether the processing amount corresponds to predetermined content. If it is determined that the processing amount corresponds, the haptics data processing unit 108 can execute step S904.

Based on the above-described processing, if the perception type of the unit haptics data and the content and processing amount of image processing satisfy predetermined conditions, the haptics data processing unit 108 determines that the perception type needs to be changed. The conditions used for the determination in steps S901 to S903 are set in advance such that the perception type is changed if the unchanged type cannot present appropriate senses of touch and force for the changed image.

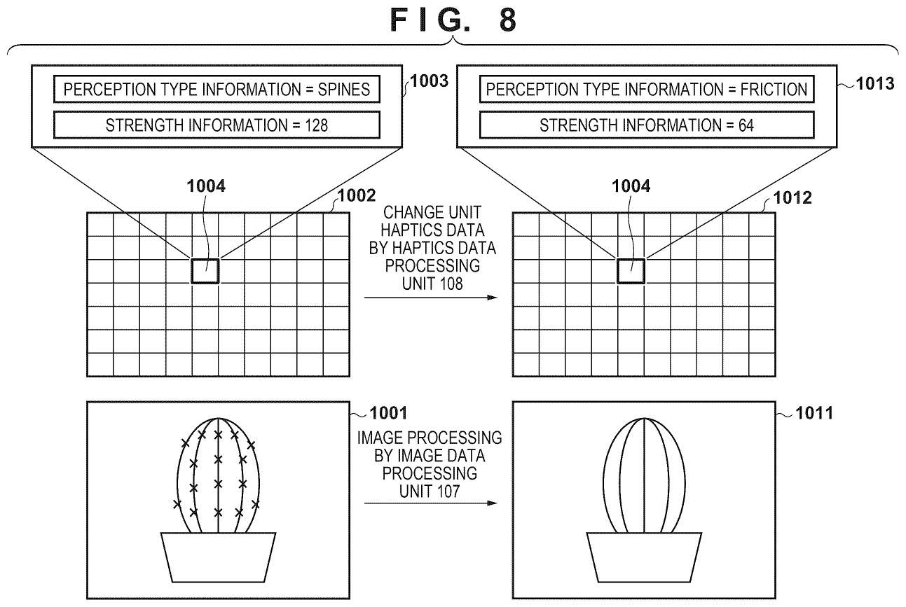

In step S904, the haptics data processing unit 108 determines the changed perception type information. An example of the operation of changing the perception type information in the haptics data processing unit 108 will be described with reference to FIG. 8.

FIG. 8 schematically illustrates an example of a change of haptics data made by the haptics data processing unit 108 when image processing is applied to an image 1001 to change it into an image 1011.

The image 1001 before applying image processing is an image focusing on a cactus. It is assumed that strong filter processing for greatly reducing sharpness has been applied by the image data processing unit 107 to at least the cactus area of this image 1001. As a result, in the image 1011 after the filter processing has been applied, the spines of the cactus are blurred and almost indistinguishable.

The area haptics data associated with an area 1004 among haptics data 1002 associated with the image 1001 includes unit haptics data 1003. Since the area 1004 corresponds to the cactus, the unit haptics data 1003 has perception type information “spines” to elicit the sensation of spines.

If the unit haptics data 1003 is maintained for the image 1011 as well, the appearance of the area 1004 in the image 1011 and the output to elicit the senses of touch and force (spacing of spines) for the area 1004 will not match. However, with unit haptics data in which the perception type information is “spines”, it is difficult to elicit appropriate senses of touch and force in a smooth-looking image area corresponding to the area 1004.

For this reason, the haptics data processing unit 108 determines that the perception type information of the unit haptics data associated with the area 1004 is to be changed from “spines” to “friction”, which can elicit the senses of touch and force corresponding to a smooth surface with little perceptual sensation, based on the following:
the perception type of the target unit haptics data being “spines” (S901, Y), and
filter processing for reducing sharpness being executed based on the image modification information (S902, Y), and the reduction in sharpness due to the filter processing being large (the processing amount being large) (S903, Y).

One example of changing the perception type information has been described herein. The haptics data processing unit 108 however, can change the perception type information according to more patterns.

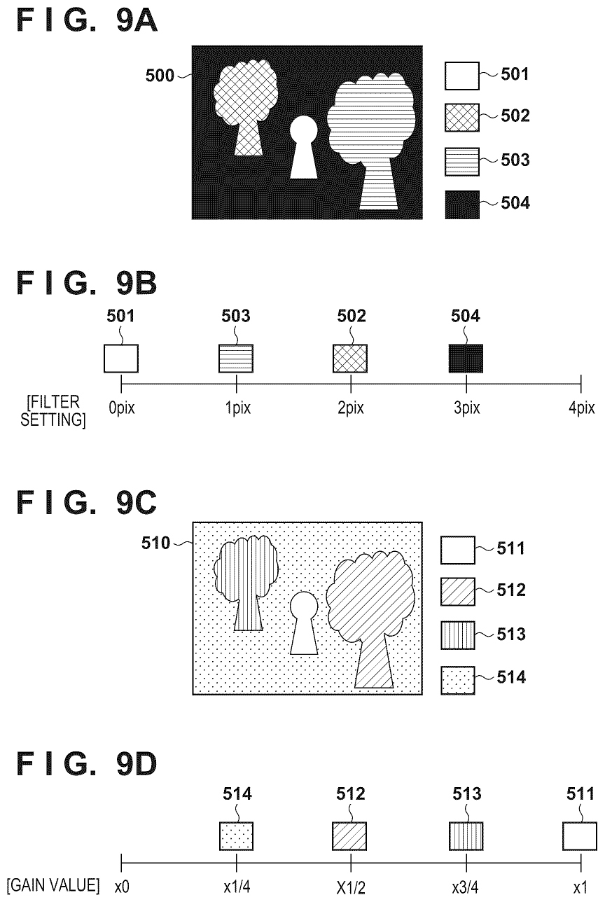

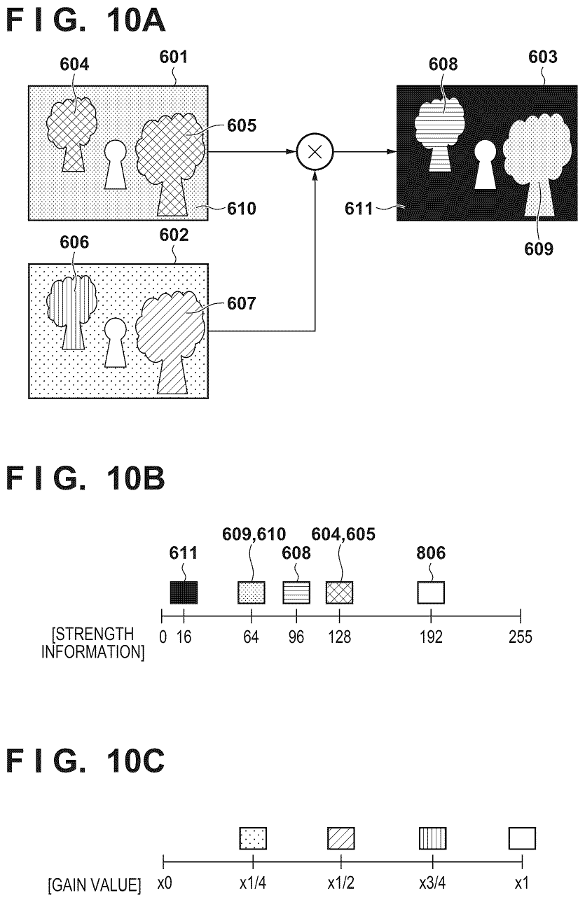

Next, a specific example of the operation of modifying the strength information in step S407 will be described with reference to FIG. 9A to FIG. 10C. FIGS. 9A to 9D illustrate schematic examples of modifying the strength information when filter processing for blurring an area other than an area of interest is applied in the image data processing unit 107. For the haptics data with the perception type information “temperature”, the strength information can be replaced with the temperature calculated in step S403, or the offset value determined in step S403 can be applied (added) to the strength information. For this reason, the operation of modifying other types of haptics data will be described herein.

In FIG. 9A, reference numeral 500 schematically represents the content of the image modification information notified from the image data processing unit 107. The content of the image processing represented by the image modification information is filter processing for reducing sharpness, and the processing amount is the strength setting value of the filter processing. For example, in the case of Gaussian filter processing, the processing amount is the set value of the blur radius, and the units are pixels. It is assumed that the image data of the image 300 in FIG. 3A is processed by the image data processing unit 107. The area of interest is also assumed to be the area of the human subject 301 in the center.

As illustrated in FIG. 9A, filter processing with different processing amounts 501 to 504 is applied to the area and background of each subject. Specific examples of the processing amounts are also illustrated in FIG. 9B. The processing amount is the setting value of the blur radius, where the larger the value is, the stronger the filter is (the more the image is blurred). Accordingly, the filter applied to the background is the strongest, followed by the filter applied to tree subject in the foreground and the filter applied to the tree subject in the back, in that order. Since the processing amount for the subject of interest is 0, filter processing is not applied thereto.

When the haptics data processing unit 108 modifies the strength information of the unit haptics data included in the area haptics data associated with the image 300, the haptics data processing unit 108 multiplies the strength information by a gain (coefficient).

In FIG. 9C, reference numeral 510 is a diagram that schematically represents the gain values that the haptics data processing unit 108 applies to the strength information, and their distribution. As illustrated in the drawing, different gains 511 to 514 are used to modify the strength information for the area and background of each subject. FIG. 9D also illustrates specific examples of the gains 511 to 514.

The magnitudes of the gains 511 to 514 have a similar relationship to the strength of the filter processing applied to the image data. Specifically, the lower the strength of filter processing is, the closer the gain value is to 1. A gain value of 1 corresponds to the strength information not being changed. The stronger the strength of filter processing is, the closer the gain value is to 0. A gain value of 0 corresponds to not performing output to elicit senses of touch and force.

Therefore, in the example illustrated in FIGS. 9A to 9D, the haptics data processing unit 108 does not modify the strength information for the haptics data associated with the area of the subject of interest. For the haptics data associated with either the two tree subjects or the background 303, the haptics data processing unit 108 applies a gain that weakens the strength of the haptics data as the strength of the filter processing becomes stronger. As a result, the lower the sharpness of an area is, the weaker the output for eliciting senses of touch and force is, and output for eliciting the senses of touch and force with a strength that is consistent with the impression provided by the appearance of the image is performed.

A case where image processing for reducing sharpness is applied has been described. However, when image processing for increasing sharpness, such as edge emphasis processing or unsharp mask processing, is applied, the strength information can be modified in a similar manner. Specifically, the haptics data processing unit 108 can modify the strength information by applying a gain exceeding 1 such that output for eliciting senses of touch and force becomes stronger in areas where the strength of the applied image processing is stronger.

FIGS. 10A to 10C illustrate an example of an operation of modifying the strength information using the gains calculated as described with reference to FIGS. 9A to 9D. FIG. 10A is a diagram schematically illustrating the content of the modification processing performed by the haptics data processing unit 108. FIGS. 10B and 10C illustrate specific examples of strength information and gain values.

In FIG. 10A, reference numeral 601 schematically indicates the distribution of the strength information of the haptics data with the perception type information “friction” associated with the image 300 before image processing is applied to the image 300. Other perception types can also be used.

Reference numeral 602 schematically indicates the gain values calculated by the haptics data processing unit 108 based on the image modification information, and their distribution. This is the same as FIG. 9C.

Reference numeral 603 schematically indicates the values and distribution of the strength information after modification, in which the strength information indicated by reference numeral 601 is multiplied by the gains indicated by reference numeral 602.

Before image processing is applied, strength information 604 and 605 of the haptics data associated with the two tree subjects are the same at 128. However, as shown in FIGS. 9A and 9B, because filter processing of different strengths is applied to the two tree subjects, the gain values 606 and 607 applied to the strength information of the respective areas are different values (½ and ¾). For this reason, the strength information 608 and 609 after the modification also have different values (96 and 64). A gain of ¼ is applied to the strength information 610 relating to the background, and the strength information 611 after modification is 16.

As described above, the haptics data processing unit 108 modifies (changes) the haptics data based on the image modification information of the image data processing unit 107 to suppress any sense of incongruity resulting from inconsistency between the image after image processing is applied and the output for eliciting senses of touch and force. For example, a case is considered in which filter processing for reducing sharpness is applied to an area associated with haptics data for eliciting a rough tactile impression. If the haptics data is not changed, the image will have low sharpness, but a rough tactile impression will still be elicited, causing the user to feel a sense of incongruity. According to the present embodiment, the haptics data processing unit 108 changes the haptics data to reduce the roughness of the tactile impression, thereby reducing the likelihood that the user will feel a sense of incongruity.

In addition, a change of the haptics data is automatically made accompanying the application of image processing. For this reason, the user need only interactively apply image processing without being aware of whether haptics data is associated with the image data being processed.

In the present embodiment, the haptics data processing unit 108 changes the strength information of the haptics data to a greater extent the greater the change in the image resulting from the applied image processing is. By setting upper and lower limits for the changed strength information, the changed strength information can be kept within an appropriate range even if the image has changed significantly due to the application of image processing.

### Second Embodiment

Next, a second embodiment will be described. Since the present embodiment can also be implemented by the image processing apparatus 100, description of the configuration of the image processing apparatus 100 will be omitted herein.

In the present embodiment, the haptics data processing unit 108 determines whether to modify the strength information of the haptics data based on the image modification processing of the image data processing unit 107. If it is determined that the strength information is to be modified, the haptics data is modified in the same manner as in the first embodiment. If it is not determined that the strength information is to be modified, the modification processing is not performed on the haptics data.

FIG. 11 is a flowchart relating to the operation of the haptics data processing unit 108 in the present embodiment. This operation can be executed, for example, when image modification information has been notified from the image data processing unit 107.

In step S1101, the haptics data processing unit 108 determines whether image processing to modify the haptics data has been applied based on the image modification information. If it is determined that image processing has been applied, the haptics data processing unit 108 executes step S1102. If it is not determined that image processing has been applied, the haptics data processing unit 108 executes step S1103. For example, if the type of the image processing described in the image modification information corresponds to the type of the image processing to modify the haptics data, which is stored in advance, the haptics data processing unit 108 determines that the image processing that is to modify the haptics data has been applied.

The type of the image processing to modify the haptics data can differ depending on the perception type of the haptics data. In this case, if it is determined that not all of the unit haptics data associated with the image data to which image processing has been applied corresponds to the type of the image processing to modify the haptics data, the haptics data processing unit 108 executes step S1103.

For example, if the image processing is processing for converting a color image into a black and white image, the color of the image is lost, but the user will not feel a sense of incongruity even if the strength information of the haptics data remains the same. In this way, since there is no need to change the strength information of the haptics data after the application of image processing, the modification of the strength information is determined to be invalid, and the modification of the strength information is not performed.

In addition, if the perception type information is temperature information, it is determined that modification of the strength information is invalid since there is no need to modify the strength information for an image that has been subjected to texture adjustment, filter processing, or the like in the image modification processing.

In step S1102, the haptics data processing unit 108 executes the processing from step S401. In step S1103, the haptics data processing unit 108 waits for notification of the next piece of image modification information without executing the processing for modifying the haptics data.

According to the present embodiment, when image processing that does not require modifying haptics data is applied, unnecessary processing is not executed, and therefore power consumption of the image processing apparatus 100 can be saved. When unnecessary modification processing is performed, there is a risk that erroneous modification of haptics data will be performed, but this can be avoided.

### Third Embodiment

A third embodiment will not be described. Since the present embodiment can also be implemented by the image processing apparatus 100, description of the configuration of the image processing apparatus 100 will be omitted herein.

In the present embodiment, the operation of the haptics data processing unit 108 in the case where the image processing applied by the image data processing unit 107 is processing for pasting an area of another image or the same image will be described. Hereinafter, it is assumed that an area of one image is pasted onto another image, but it is also possible to duplicate and paste an area within the same image.

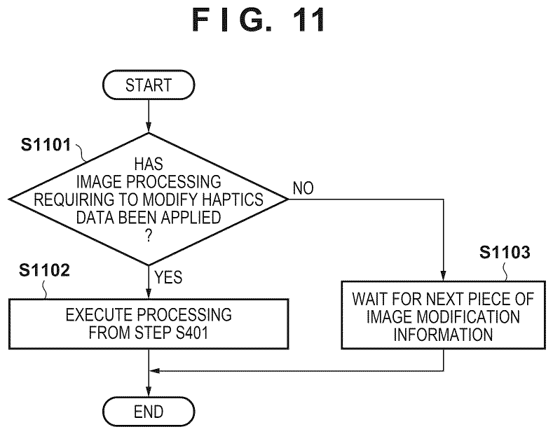

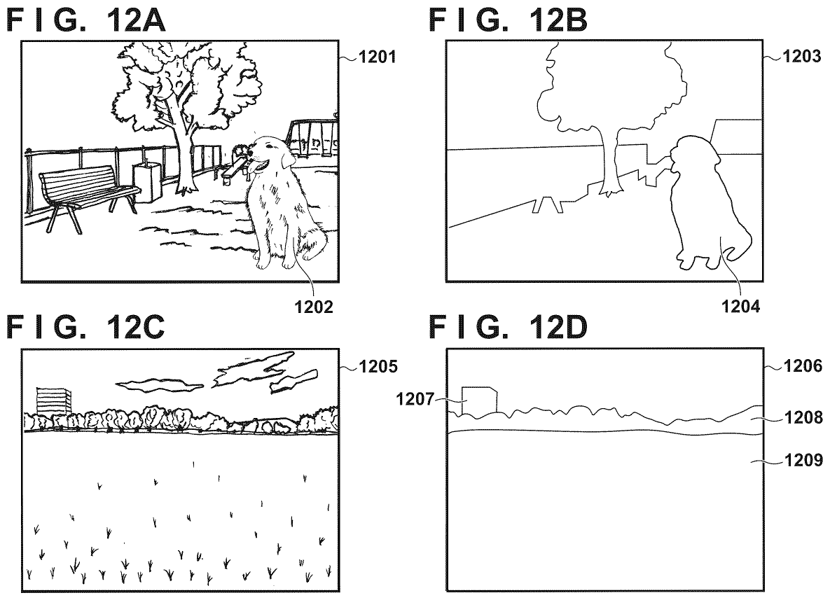

First, the image data before modification will be described with reference to FIGS. 12A to 12D. FIGS. 12A and 12C illustrate images represented by image data before the application of image processing. In addition, the perception type information of the haptics data associated with each image is illustrated diagrammatically in FIG. 12C and FIG. 12D. The haptics data is associated with each area of the image.

An image 1201 of FIG. 12A is an image that includes an area to be pasted onto another image. In this example, the image 1201 is an image of a dog 1202 in a park. Reference numeral 1203 in FIG. 12B schematically indicates a distribution of the perception type information of the haptics data associated with the image 1201. For example, an area 1204 of the dog 1202 is associated with haptics data that represents a tactile impression of the dog's fur.

FIG. 12C illustrates an image (background image) 1205 onto which an area image of another image is to be pasted, and in this case, it is an image of a grass field. Reference numeral 1206 in FIG. 12D schematically indicates a distribution of the perception type information of the haptics data associated with the image 1205. Specifically, an area 1207 is associated with haptics data that for realizing a tactile impression corresponding to buildings, an area 1208 is associated with haptics data for realizing a tactile impression corresponding to trees, and an area 1209 is associated with haptics data for realizing a tactile impression corresponding to grass.

It is assumed that the data of the images 1201 and 1205 and the associated haptics data are stored in advance in the storage medium 106.

Next, the image processing applied by the image data processing unit 107 will be described. It is assumed that an image editing application program is being executed by the CPU 102 in the image processing apparatus 100, and that the image 1201 and the image 1205 are displayed side by side as objects to be edited.

When the image data processing unit 107 detects an instruction to select an area of the image 1201, specifically, the area of the dog 1202, via the operation unit 109, the image data processing unit 107 executes known contour detection processing and the like to place the area of the dog 1202 in a selected state. In this state, when a copy (or cut) instruction is detected through the operation unit 109, the image data processing unit 107 stores the data of the area of the dog 1202 in, for example, a clipboard provided by the OS. Then, when a paste instruction is detected through the operation unit 109 while the image 1205 is focused, the image data processing unit 107 causes the image of the dog 1202 stored on the clipboard to be displayed superimposed on the image 1205 in a selected state. When an operation to cancel the selected state is detected, the image data processing unit 107 composites the image of the dog 1202 with the image 1205. The compositing can be replacement or can be a pixel-by-pixel logical operation.

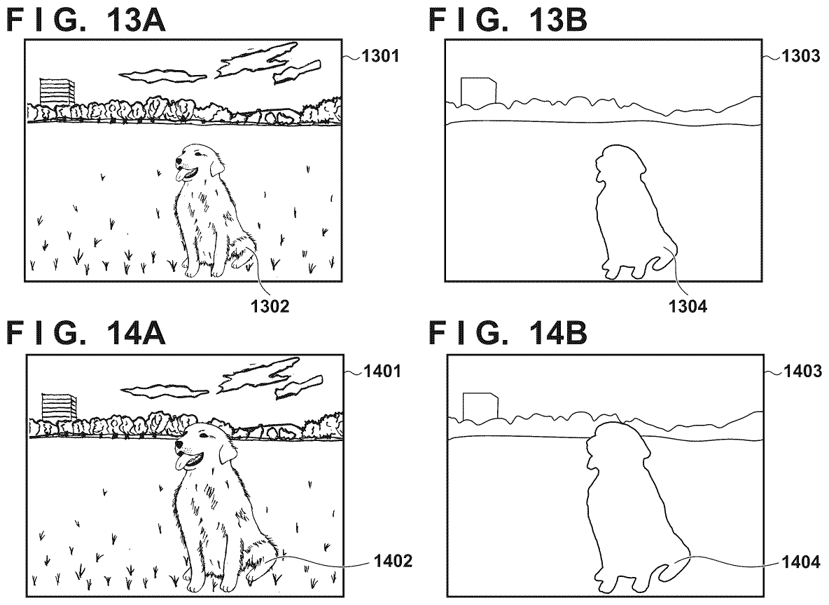

FIG. 13A illustrates an image 1301 in which an image of a dog 1302 has been composited with the image 1205. When the image data processing unit 107 completes the image compositing, the image data processing unit 107 notifies the haptics data processing unit 108 of the image modification information. The image modification information relating to image processing for pasting (compositing) an area of one image onto another image includes information on the pasted area (information specifying its position and contour in the one image) and information specifying the compositing position in the background image.

That is, in this example, the image modification information includes coordinate position information and contour information of the area of the dog 1202 in the image 1201 (modification source area information), and coordinate position information of the area of the dog 1302 in the image 1301 (modification destination area information).

Next, the operation of the haptics data processing unit 108 will be described. The haptics data processing unit 108 acquires the haptics data 1203 and 1206 from the RAM 104 based on the image modification information notified by the image data processing unit 107. Then, the haptics data processing unit 108 reflects the paste (compositing) processing applied by the image data processing unit 107 in the haptics data 1206. FIG. 13B schematically indicates haptics data 1303 in which the haptics data processing unit 108 has reflected the paste (compositing) processing. The image 1301 and the haptics data 1303 are associated with each other and then stored, for example, in the storage medium 106.

The reflection of the paste (compositing) processing on the haptics data can be realized by executing an operation similar to the paste (compositing) processing performed on the image on the haptics data 1203 and 1206.

Specifically, the haptics data processing unit 108 copies or cuts, from the haptics data 1203, the haptics data of the area indicated by the modification source area information included in the image modification information. Then, the haptics data processing unit 108 replaces the haptics data of the area indicated by the modification destination area information included in the image modification information in the haptics data 1206 with the copied or cut haptics data.

If haptics data is associated with each rectangular area of an image as described in the first embodiment, the haptics data processing unit 108 also copies (cuts) and replaces the haptics data in units of rectangular areas.

In this way, when image processing for pasting an area of another image is applied, the haptics data processing unit 108 reflects the haptics data associated with that area in the haptics data associated with the image that is the paste destination.

As a result, the haptics data for the grass portion on which the image of the dog is pasted is replaced from the haptics data of the grass to the haptics data representing the dog's fur, thereby making it possible to achieve consistency between the image and the haptics data.

The same processing can also be executed when pasting an area within the same image. For example, in the image shown in FIG. 12A, the area of the dog 1202 is duplicated to increase the number of dogs. In this case, the haptics data associated with the area in which the duplicate of the area of the dog 1202 was pasted can be replaced with the haptics data associated with the area of the dog 1202.

The image data processing unit 107 can perform a modification such as enlarging, reducing, inverting, or rotating the copied or cut image area before pasting it. In this case, the image data processing unit 107 includes information on the modification method and the modification content in the modification source area information included in the image modification information. The modification method information includes “enlargement”, “reduction”, “inversion”, “rotation”, and the like. The information on the modification content is a parameter (for example, an enlargement ratio, a reduction ratio, a rotation angle, etc.) corresponding to the modification method.

If the modification source area information includes information related to modification, the haptics data processing unit 108 reflects the modification in the haptics data associated with the copied or cut image area and then uses the haptics data for replacement.

FIGS. 14A to 14B illustrate an example in which image processing for enlarging the area of the dog 1202 in FIG. 12A and then pasting the result onto the image 1205 is applied. FIG. 14A shows an image 1401 after image processing. FIG. 14B schematically indicates haptics data 1403 associated with the image 1401. It can be understood that in comparison with the haptics data 1304 in FIG. 13B, the range of haptics data 1404 has been enlarged to correspond to an area 1402 of the dog after enlargement.

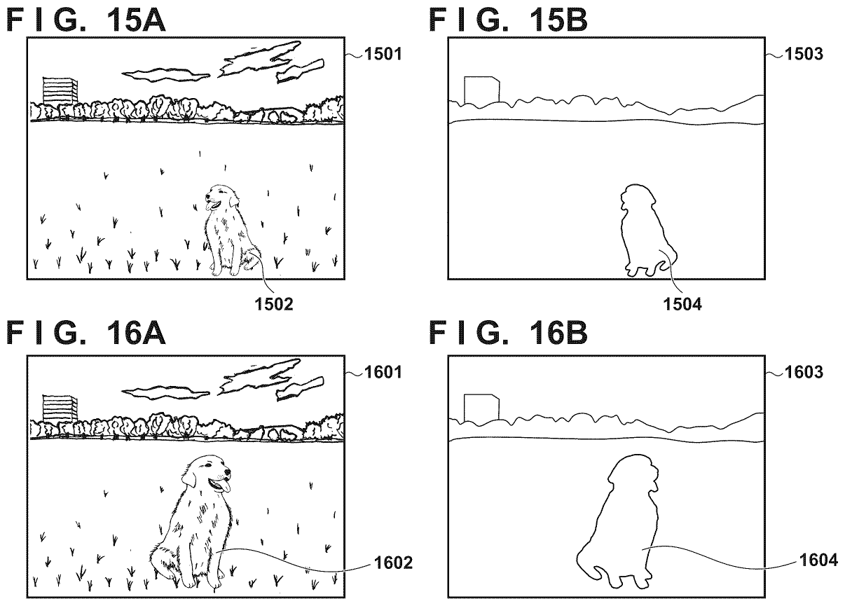

FIGS. 15A and 15B illustrate examples in which image processing for reducing the area of the dog 1202 in FIG. 12A and then pasting the result onto the image 1205 is applied. FIG. 15A illustrates an image 1501 after image processing. FIG. 15B schematically indicates haptics data 1503 associated with the image 1501. It can be understood that in comparison with the haptics data 1304 of FIG. 13B, the range of haptics data 1504 has been reduced to correspond to an area 1502 of the dog after reduction.

FIGS. 16A and 16B illustrate an example in which image processing for horizontally inverting the area of the dog 1202 in FIG. 12A and then pasting the result onto the image 1205 is applied. FIG. 16A illustrates an image 1601 after image processing. FIG. 16B schematically indicates haptics data 1603 associated with image the 1601. It can be understood that in comparison with the haptics data 1304 in FIG. 13B, the area of haptics data 1604 has been inverted to correspond to the area 1602 of the dog after inversion.

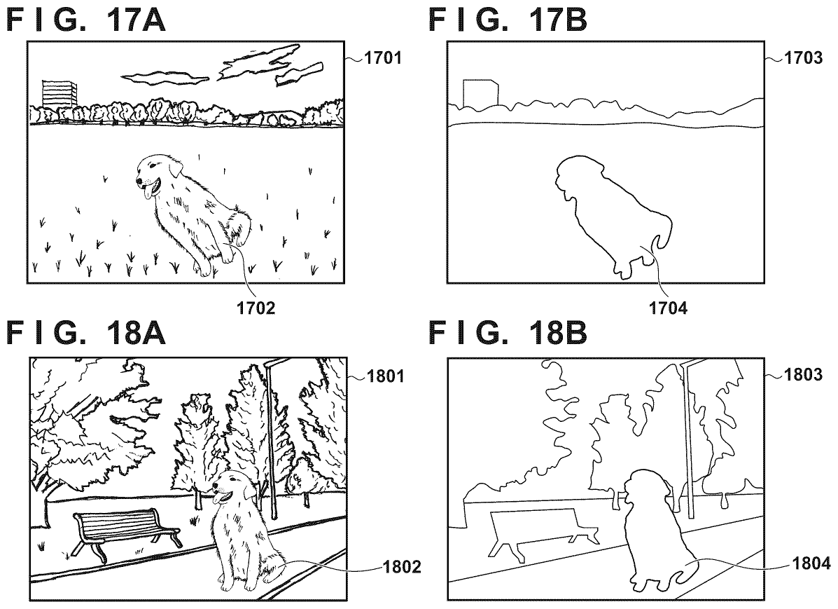

FIGS. 17A and 17B illustrate an example in which image processing for rotating the area of the dog 1202 in FIG. 12A counterclockwise and then pasting the result onto the image 1205 is applied. FIG. 17A illustrates an image 1701 after image processing. FIG. 17B schematically indicates haptics data 1703 associated with the image 1701. It can be understood that in comparison with the haptics data 1304 in FIG. 13B, the area of haptics data 1704 has been rotated to correspond to the area 1702 of the rotated dog.

The haptics data is data associated with each area of the image data. In particular, if haptics data is associated with each image area divided at equal intervals in the horizontal and vertical directions, as illustrated in FIG. 2, the haptics data can be considered to be data obtained by discretely sampling space, similarly to image data. For this reason, methods of enlarging, reducing, inverting, and rotating image data can also be applied to haptics data. For example, the haptics data can be enlarged or reduced by linearly interpolating or thinning out.

Modification applied before pasting is not limited to enlargement, reduction, inversion, and rotation. It is also possible to apply another modification, such as transformation, or to combine a plurality of modification methods.

According to this embodiment, when image processing for pasting an image is applied, the haptics data associated with the original image to be pasted is reflected in the haptics data associated with the image that is the paste destination. For this reason, it is possible to maintain consistency between the image and the haptics data after applying image processing. Note that the description here is premised on the fact that haptics data is associated with the image to be pasted (area image). However, if no haptics data is associated with the area image, the haptics data associated with the paste destination area can be deleted.

### Fourth Embodiment

Next, a fourth embodiment will be described. Since this embodiment can also be implemented by the image processing apparatus 100, description of the configuration of the image processing apparatus 100 will be omitted. herein

In this embodiment, the operation of the haptics data processing unit 108 is related to the case where the image data processing unit 107 applies image processing for erasing the subject in an image. Erasure of the subject is an operation of replacing the area of the subject with the background.

FIG. 18A illustrates an image 1801 before image processing is applied. FIG. 18B also schematically indicates haptics data 1803 associated with the image 1801. The image 1801 illustrates a dog 1802 sitting in a park. Also, the area of the dog 1802 is associated with haptics data 1804 that expresses the dog's fur.

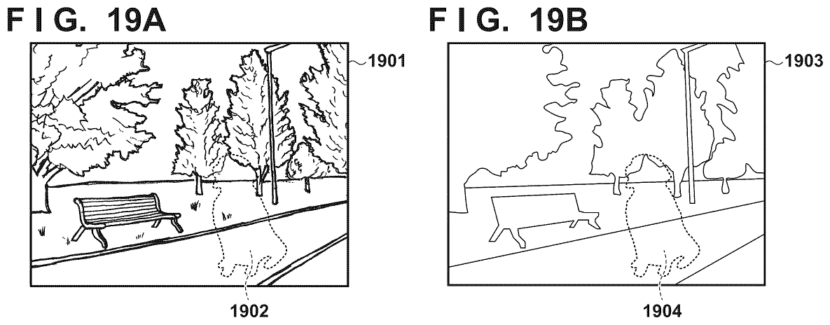

Next, the image processing applied by the image data processing unit 107 will be described. It is assumed that an instruction to erase the dog 1802 in the image 1801 has been detected via the operation unit 109. In response to the instruction, the image data processing unit 107 replaces the area of the dog 1802 in the image data stored in the RAM 104 with a background image estimated from the surrounding image. FIG. 19A illustrates an image 1901 after image processing has been applied.

In the image 1901, an area 1902 indicated by a dashed line has had the image of the dog replaced with a background image. This background image is generated by estimation from the surrounding background. Since background image estimation is a known technique implemented in commercially available image editing applications, detailed description thereof will be omitted.

When the image data processing unit 107 applies image processing to the image 1801, the image data processing unit 107 notifies the haptics data processing unit 108 of image modification information describing the applied image processing. When processing for erasing a subject is applied, the image modification information includes information indicating the type of image processing and information specifying the area to which the processing was applied (for example, information indicating the contour or position of the area). In the example of FIGS. 18A to 18B, the image modification information includes subject erasure as the type of image processing, and information specifying the area of the dog 1802 as information specifying the area.

Next, the operation of the haptics data processing unit 108 will be described. The haptics data processing unit 108 recognizes that the subject erasure processing has been applied based on the image modification information notified from the image data processing unit 107. The haptics data processing unit 108 acquires haptics data associated with the surrounding area of the target area based on the image modification information, for example, from the haptics data 1803 stored in the RAM 104. Here, the haptics data associated with the surrounding area of the target area is acquired in order to generate haptics data for replacing the haptics data associated with the target area.

As described above, haptics data can be handled in the same way as image data. For this reason, the haptics data processing unit 108 applies to the haptics data the same method that the image data processing unit 107 uses to generate a background image to replace the area of the dog 1802. This allows the haptics data processing unit 108 to generate haptics data 1904 to replace the haptics data 1804 associated with the area of the dog 1802.

The haptics data processing unit 108 replaces the haptics data 1804 stored in the RAM 104 with the haptics data 1904 generated by estimated from the surrounding haptics data.

This makes it possible to suppress inconsistency between the image and the output for eliciting senses of touch and force, for example, when the feeling of a dog's fur is elicited for the area 1902 in the image 1901.

According to this embodiment, when object erasure processing is applied, the haptics data associated with the area of the erased object is replaced with background haptics data inferred from the haptics data associated with the surrounding areas. For this reason, it is possible to maintain consistency between the image and the haptics data after applying image processing.

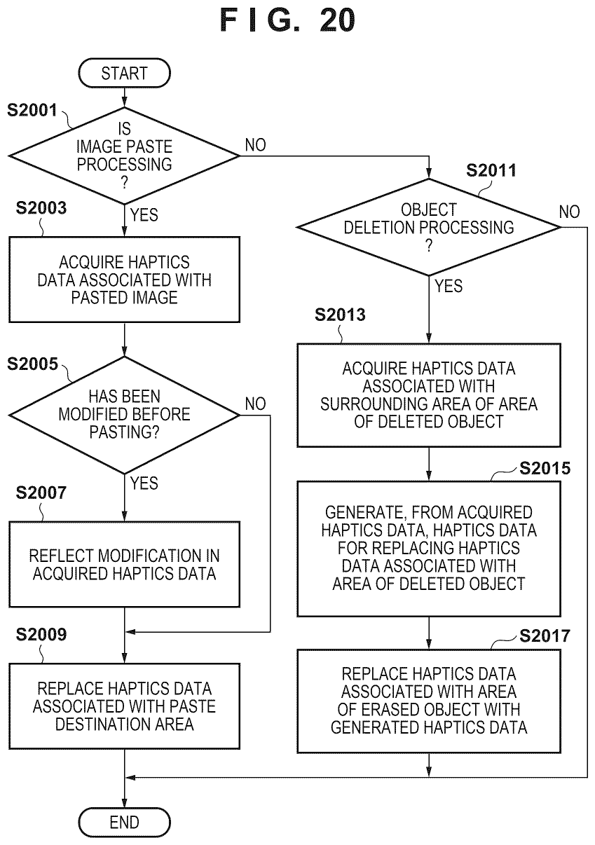

FIG. 20 is a flowchart relating to the operation of the haptics data processing unit 108 in the third and fourth embodiments.

In step S2001, the haptics data processing unit 108 determines whether or not the applied image processing is image paste processing, based on the image modification information. Here, it is assumed that the paste source image has haptics data associated with it. If it is determined that the applied image processing is image paste processing, the haptics data processing unit 108 executes step S2003, and if not, the haptics data processing unit 108 executes step S2011.

In step S2003, the haptics data processing unit 108 acquires haptics data associated with the pasted image (area image) from, for example, the RAM 104.

In step S2005, the haptics data processing unit 108 determines whether or not the area image has been modified before pasting. If it is determined that the data has been modified, the haptics data processing unit 108 executes step S2007, and if not, the haptics data processing unit 108 executes step S2009.

In step S2007, the haptics data processing unit 108 reflects the modification applied to the area image in the haptics data acquired in step S2003.

In step S2009, the haptics data processing unit 108 replaces the haptics data associated with the paste destination area with the haptics data acquired in step S2003 or obtained in step S2007, and ends the processing based on the notified image modification information.

In step S2011, the haptics data processing unit 108 determines whether or not the applied image processing is object deletion processing based on the image modification information. If it is determined that the applied processing is object erasure processing, the haptics data processing unit 108 proceeds to step S2013, and if not, the haptics data processing unit 108 ends the processing in FIG. 20. Note that if it is not determined that the applied image processing is object erasure processing, the haptics data processing unit 108 can execute the processing from step S401 in FIG. 4.

In step S2013, the haptics data processing unit 108 acquires, for example, from the RAM 104, haptics data associated with the surrounding area of the area of the deleted object in the image data.

In step S2015, the haptics data processing unit 108 generates, from the acquired haptics data, haptics data for replacing the haptics data associated with the area of the deleted object.

In step S2017, the haptics data processing unit 108 replaces the haptics data associated with the area of the erased object with the haptics data generated in step S2015, and ends the processing based on the notified image modification information.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-216197, filed Dec. 21, 2023, which is hereby incorporated by reference herein in its entirety.

What is claimed is:

1. An image processing apparatus that applies image processing to image data with which haptics data to be used to elicit senses of touch and force is associated, the image processing apparatus comprising:
one or more processors that execute a program stored in a memory to:
change, if image processing, which relates to a change of a value set for the image data, has been applied to the image data, first haptics data, which is haptics data associated with, in the image data, data of an area to which the image processing has been applied, to elicit senses of touch and force corresponding to an image represented by the data of the area after the image processing has been applied.

2. The image processing apparatus according to claim 1,
wherein the haptics data is associated with an area of the image represented by the image data, and
area haptics data associated with one area includes one or more pieces of unit haptics data, where the unit haptics data includes a combination of type information and strength information of senses of touch and force.

3. The image processing apparatus according to claim 2, wherein the change unit changes the haptics data for each piece of the unit haptics data.

4. The image processing apparatus according to claim 3, wherein the change unit does not change the type information of the unit haptics data for which the type information is temperature.

5. The image processing apparatus according to claim 2, wherein if a type of the image processing is a predetermined type and a processing amount of the image processing is greater than or equal to a predetermined threshold, the change unit changes the type information and the strength information of the unit haptics data included in the first haptics data.

6. The image processing apparatus according to claim 5, wherein if the type of the image processing is not a predetermined type, or if the type of the image processing is the predetermined type but the processing amount is less than the predetermined threshold, the change unit changes the strength information without changing the type information of the unit haptics data included in the first haptics data.

7. The image processing apparatus according to claim 2, wherein if the image processing is a change of color temperature, the strength information is changed for the unit haptics data that is included in the first haptics data and for which the type information is temperature, such that an elicited temperature decreases when the color temperature increases and the elicited temperature increases when the color temperature decreases.

8. The image processing apparatus according to claim 2, wherein if the image processing is filter processing for reducing sharpness, the unit haptics data included in the first haptics data is changed to reduce tactile sensation to be elicited.

9. The image processing apparatus according to claim 2, wherein if the image processing is filter processing for changing sharpness, the strength information of the unit haptics data included in the first haptics data is changed by applying a gain having a value corresponding to a magnitude of a processing amount of the filter processing.

10. The image processing apparatus according to claim 2, wherein if the image processing is filter processing for changing sharpness, the strength information of the unit haptics data included in the first haptics data is changed by applying a gain having a value corresponding to a magnitude of a processing amount of the filter processing.

11. The image processing apparatus according to claim 1, wherein if the image processing is pasting of an image with which haptics data is associated and the image to be pasted is modified before being pasted, the modification is reflected in the haptics data associated with the image to be pasted and the first haptics data is replaced.

12. The image processing apparatus according to claim 11, wherein the modification includes one or more of enlargement, reduction, rotation, inversion, or transformation.

13. The image processing apparatus according to claim 1, wherein if the image processing is erasure of an object, the first haptics data is replaced with haptics data estimated from the haptics data associated with a surrounding area of the object in the image represented by the image data.

14. The image processing apparatus according to claim 1, wherein the first haptics data is not changed if the image processing does not require a change of the haptics data.

15. An image processing method for applying image processing to image data with which haptics data to be used to present a sense of touch and force is associated, the method comprising
changing, if image processing relating to a change of a value set for the image data has been applied, first haptics data, which is haptics data associated with, in the image data, image data of an area to which the image processing has been applied, so elicit senses of touch and force corresponding to an image represented by the image data of the area after the image processing has been applied.

16. The image processing method according to claim 15,
wherein the haptics data is associated with an area of the image represented by the image data, and
area haptics data associated with one area includes one or more pieces of unit haptics data, where the unit haptics data includes a combination of type information and strength information of senses of touch and force.

17. The image processing method according to claim 15, wherein if the image processing is pasting of an image with which haptics data is associated and the image to be pasted is modified before being pasted, the modification is reflected in the haptics data associated with the image to be pasted and the first haptics data is replaced.

18. The image processing method according to claim 15, wherein if the image processing is erasure of an object, the first haptics data is replaced with haptics data estimated from the haptics data associated with a surrounding area of the object in the image represented by the image data.

19. The image processing method according to claim 15, wherein the first haptics data is not changed if the image processing does not require a change of the haptics data.

20. A non-transitory computer-readable medium storing a program having instructions that, when executed by a computer, cause the computer to execute an image processing method for applying image processing to image data with which haptics data to be used to present a sense of touch and force is associated, the method comprising
changing, if image processing relating to a change of a value set for the image data has been applied, first haptics data, which is haptics data associated with, in the image data, image data of an area to which the image processing has been applied, to elicit senses of touch and force corresponding to an image represented by the image data of the area after the image processing has been applied.
